(19) United States
(12) Patent Application Publication
(10) Pub. No.: US 2008/0208548 A1
(43) Pub. Date: Aug. 28, 2008

(54) Credit Report-Based Predictive Models

(75) Inventors: Scott Metzger, San Luis Obispo, CA (US); John Thomas Danaher, Hinsdale, IL (US)

Correspondence Address: Law Office of Mark J. Spolyar, 38 Fountain Street, San Francisco, CA, 94114, US

(73) Assignee: TransUnion Interactive, Inc., a Delaware corporation

(21) Appl. No.: 12/037,630

(22) Filed: Feb. 26, 2008

Related U.S. Application Data
(60) Provisional application No. 60/891,913, filed on Feb. 27, 2007.

(51) Int. Cl. G06G 7/48

(52) U.S. Cl. 703/6

(57) ABSTRACT

An example embodiment provides for systems, apparatuses and methods directed to determining the likelihood that a given individual may need or obtain a credit product. This is accomplished by obtaining non-contemporaneous snapshots of credit files and using the non-contemporaneous snapshots to build a predictive model to determine a likelihood that a given individual will be needing a credit product. In one implementation, the credit product is a non-credit product. Other systems, apparatuses and methods can also be employed to sell preferential placement of advertisements on a website.

### CROSS-REFERENCE TO RELATED APPLICATION

The present application claims priority to U.S. Provisional Application Ser. No. 60/891,913 filed Feb. 27, 2007, which is incorporated by reference herein for all purposes.

### TECHNICAL FIELD

The present invention relates generally to credit files and more particularly to predictive behavior models generated from credit file histories.

### BACKGROUND

Credit file data mining traditionally aims to identify individuals qualified to be offered new lines of credit, or to alert users to new entries in a credit history. This approach is lacking, however, in that it fails to identify individuals who are likely to need credit-related or other financial products. Due to this, a need exists in the art for systems, apparatuses and methods that can accurately identify individuals that are likely to need credit products.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, apparatuses and methods which are meant to be exemplary and illustrative, not limiting in scope. In various embodiments, one or more of the above-described problems have been reduced or eliminated.

The present invention provides methods, apparatuses and systems directed to advertisement selection that utilizes models of user behavior and responsiveness to advertisements relative to one or more attributes of credit history. One embodiment by way of non-limiting example provides for systems, apparatuses and methods directed to determining the likelihood that a given individual may need or obtain a credit product. This can be accomplished by obtaining non-contemporaneous snapshots of credit files and using the non-contemporaneous snapshots to build a predictive model to determine a likelihood that a given individual may need or obtain a credit product, such as a home equity loan, car loan, and the like. In other implementations, the invention can be used in connection with non-credit products. Other systems, apparatuses and methods can also be employed to offer and sell preferential placement of advertisements on a website.

In addition to the aspects and embodiments described above, further aspects and embodiments will become apparent by reference to the drawings and by study of the following descriptions.

### BRIEF DESCRIPTION OF THE DRAWINGS

Example embodiments are illustrated in referenced figures of the drawings. It is intended that the embodiments and figures disclosed herein are to be considered illustrative rather than limiting.

FIG. 1 is a functional block diagram illustrating a computer network environment including the functionality associated with a first embodiment of the present invention;

FIG. 2 is, for didactic purposes, a block diagram of a hardware system, which can be used to implement portions of the claimed embodiments;

FIG. 3 is a flowchart diagram illustrating a method for constructing a predictive model based on credit files, in accordance with an example embodiment;

FIG. 4 is a flowchart diagram illustrating a method for constructing a predictive model based on correlation between attributes of a credit file and attributes of an advertisement, in accordance with an example embodiment; and

FIG. 5 is a flowchart diagram illustrating a method for constructing a predictive model which is in turn utilized to sell preferential placement of advertisements on a web site, in accordance with an example embodiment.

FIG. 6 is a stick diagram illustrating message flows according to one possible implementation of the invention.

### DETAILED DESCRIPTION

The following embodiments and aspects thereof are described and illustrated in conjunction with systems, apparatuses and methods which are meant to be illustrative, not limiting in scope.

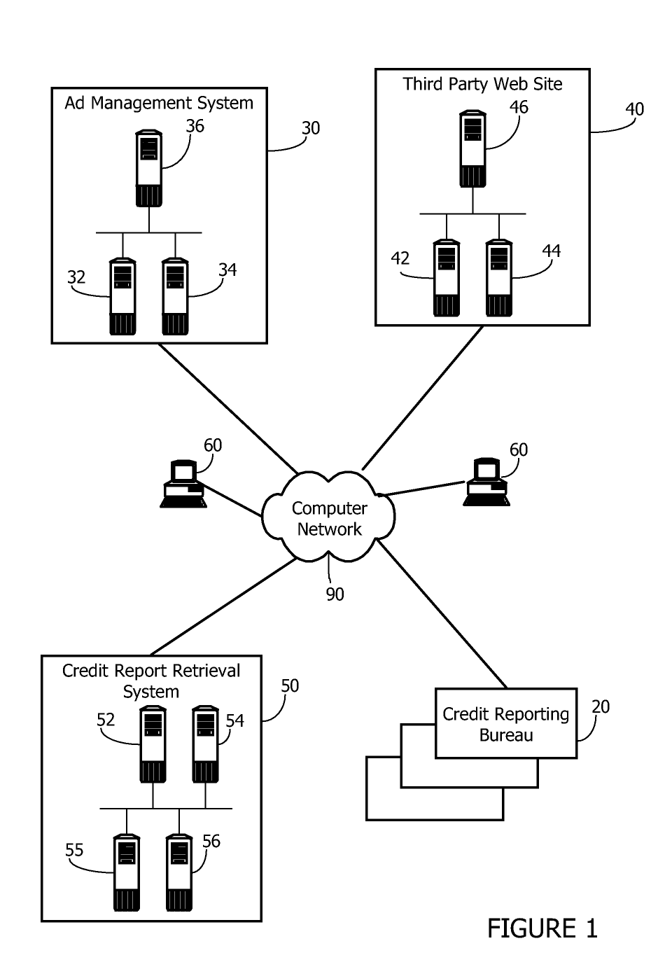

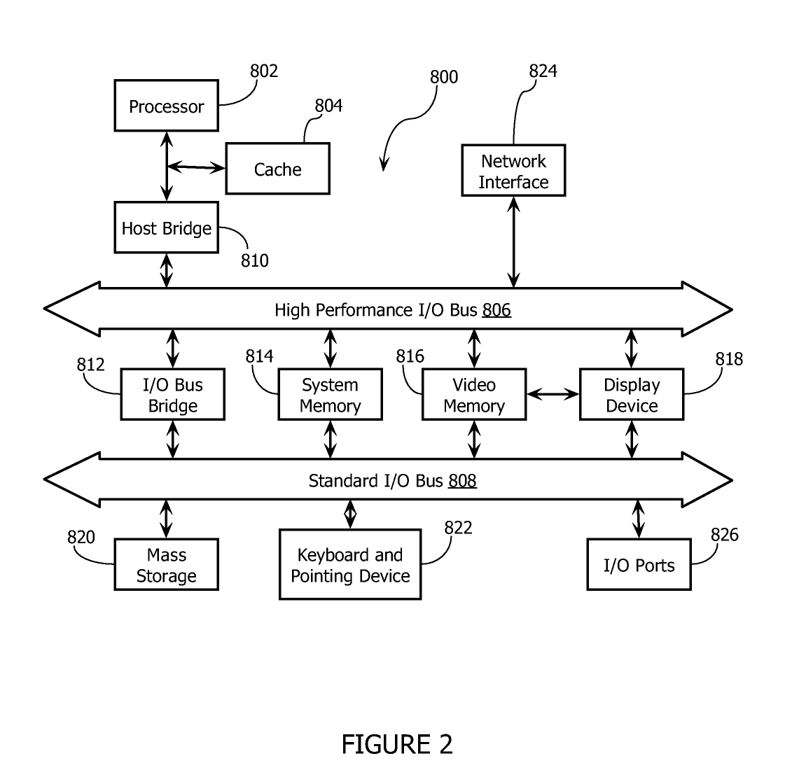

FIGS. 1-2 provide example frameworks and system architectures in which embodiments of the invention may operate. FIG. 1 illustrates a computer network environment comprising at least one credit reporting bureau 20, an ad management system 30, third party web site 40, credit data retrieval system 50, and at least one client computer 60 associated with one or more individual users. Computer network 90 can be any suitable computer network, including the Internet or any wide area network. In one embodiment, users access credit data retrieval system 50 over computer network 90 with a network access device, such as client computer 60 including suitable client software, such as a web browser, for transmitting requests and receiving responses over a computer network. However, suitable network access devices include desktop computers, laptop computers, Personal Digital Assistants (PDAs), and any other wireless or wireline device capable of exchanging data over computer network 90 and providing a user interface displaying data received over computer network 90. In one embodiment, the present invention operates in connection with an HTML compliant browser, such as the Microsoft Internet Explorer®, Netscape Navigator® and Mozilla Firefox® browsers.

In one embodiment, credit data retrieval system 50 comprises Web/HTTP server 52, application server 54, database server 56 and web services network gateway 55. Web/HTTP server 52 is operative to establish HTTP or other connections with client computers 60 (or other network access devices) to receive requests for files or other data over computer network 90 and transmit responses in return, as discussed herein. In one implementation, Web/HTTP server 52, in one embodiment, incorporates HTTP server and connection state management functionality. In one embodiment, Web/HTTP server 52 passes requests to application server 54 which composes a response and transmits it to the user via web server 52. In one embodiment, web server 52 establishes a secure connection to transmit data to users and other sites, using the SSL (“Secure Sockets Layer”) encryption protocol part of the HTTP(S) (“Secure HTTP”) protocol, or any other similar protocol for transmitting confidential or private information over an open computer network. Database server 56 stores the content and other data associated with operation of credit data retrieval system 50. Application server 54, in one embodiment, includes the functionality handling the overall process flows, described herein, associated with credit data retrieval system 50. Application server 54, in one embodiment, accesses database server 56 for data (e.g., HTML page content, etc.) to generate responses to user requests and transmit them to web server 52 for ultimate transmission to the requesting user. As one skilled in the art will recognize, the distribution of functionality set forth above among web server 52, database server 56 and application server 54 is not required by any constraint. The functionality described herein may be included in a single logical server or module or distributed in separate modules. In addition, the functionality described herein may reside on a single physical server or across multiple physical servers. In addition, although one web server 52 is depicted in FIG. 1, multiple web servers may be used in connection with session clustering to store session state information in a central database for use by the multiple web servers, and to provide for failover support.

Advertising management system 30 is a network addressable system that hosts functionality that allows advertisers to submit advertisements, including ad creative files and metadata regarding the advertisements. Typically, individual ads are associated with a unique identifier. Advertising management system 30, in one embodiment, also hosts the ads themselves and provides ad data in response to requests from remote systems. In one embodiment, advertising management system 30 comprises web server 32, application server 34 and database server 36. Web server 32 receives requests for files or other data over computer network 40 and passes them to application server 34. In one embodiment, web server 32 transmits data to users and other sites using HTTP and related protocols, or any other similar protocol for transmitting data over a computer network. In one embodiment, database server 36 stores content and other data relating to the operation of the advertiser web site 30. Application server 34, according to one embodiment, accesses database server 36 and generates pages or other files that web server 32 transmits over computer network 90 to the intended recipient.

Third party web site 40 is a network addressable system that hosts a network application accessible to one or more users over a computer network. The network application may be an informational web site where users request and receive identified web pages and other content over the computer network. The network application may also be an on-line forum or blogging application where users may submit or otherwise configure content for display to other users. The network application may also be a social network application allowing users to configure and maintain personal web pages. The network application may also be a content distribution application, such as Yahoo! Music Engine®, Apple® iTunes®, podcasting servers, that displays available content, and transmits content to users. As FIG. 1 illustrates, third party web site 40 may comprise one or more physical servers 42, 44, 46.

Credit reporting bureau 20 maintains a database or other repository of credit history data for at least one individual or other entity, such as the credit reporting services offered by TransUnion®, Equifax®, and Experian®. Credit reporting bureau(s) 20 offer web-based credit reporting application services. In one embodiment, credit data retrieval system 50 operates in connection with one credit reporting bureau, such as TransUnion, Equifax, or Experian; however, in other embodiments, credit data retrieval system 50 obtains credit report data for a particular individual from at least two credit reporting bureaus 20 and merges the data into a single report or record.

As discussed above, credit data retrieval system 50 may further include network services gateway 55 which implements web services network functionality to process and route service requests and responses over a computer network. In one embodiment, network services gateway 55 implements a communications model based on requests and responses. Network services gateway 55 generates and transmits a service request to an external vendor, such as credit reporting bureau 20 and/or credit scoring engine 25, which receives the request, executes operations on data associated with the request, and returns a response. Network services gateway 55, in one embodiment, further includes other web services functionality such as logging of service requests and responses allowing for tracking of costs and usage of services. Network services gateway 55, in one embodiment, relies on secure HTTP communications and XML technologies for request and response formats. In one embodiment, network services gateway 55 maintains Document Type Definitions (DTDs) and/or XML Schema Definitions (XSDs) that define the format of the XML request and XML response. Request and response XSDs, in one form, include a message type, transaction identification, vendor/service identification, and an application identification. As one skilled in the art will recognize various embodiments are possible. For example, the credit retrieval functionality of system 50 may be incorporated into the functionality of credit reporting bureau 20.

Credit data retrieval system 50, in some particular implementations, offers its users the ability to obtain credit report information by advertising these services on the web pages, such as its home page, it serves to users. Users who opt for such services click on links or otherwise communicate a request to order the services, thereby triggering the methodology and protocols discussed below. Typically, a user supplies sufficient identifying information (such as full name, current address, social security number, etc.) to allow for retrieval of the user's credit history. In response to a request for a user's credit history, credit data retrieval system 50 accesses one or more credit reporting bureaus 20 and obtains the credit history files associated with the user. Credit data retrieval system 50 may then store the obtained credit history data in association with a user account.

The web pages served to users may include one or more advertisements, such as banner ads and text-based ads, in reserved locations of the web page. Credit data retrieval system 50, on a periodic basis, may access advertising management system 30 to obtain data related to the ads managed by that system. The data maintained by advertising management system 30 may include ad identifiers and meta data regarding one or more attributes of the ad (such as ad type/category, subject matter of offer), as well as target user attributes, such as demographics and profile information. Credit data retrieval system 50 can store this information locally, and refresh it periodically, to reduce the time it takes to select ads for display.

When constructing a given web page in response to a user request, credit data retrieval system 50 may select an ad, as discussed in more detail below, and then add HTML and/or other browser-executable code (such as Javascript) that identifies the ad to the web page. This code (HTML code and/or Javascript) may be embedded in a frame (e.g., an i-frame) of the page. When the web page is received and processed by a client application, such as a web browser, the client host processes the code and transmits a request for the identified ad to advertising management system 30. The code embedded in the frame of the page may further include a user identifier, and other meta data. The user identifier and other data may be appended to the request for the ad, which advertising management system 30 can store in a log. Accordingly, credit data retrieval system 50 can subsequently access these logs to determine which users clicked on which advertisements, and correlate one or more attributes of the advertisements to one or more attributes of the users and their respective credit histories.

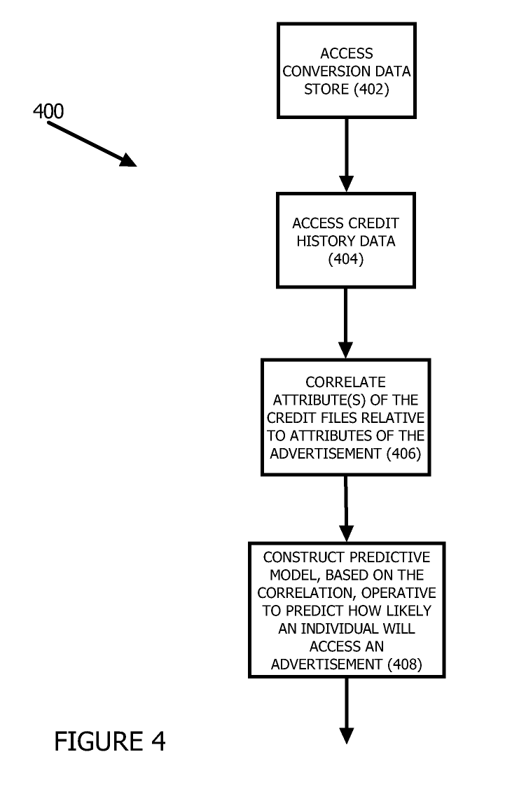

FIG. 4 is a flowchart diagram illustrating a method 500 for constructing a predictive model which can be utilized to select one or more advertisements for inclusion in a web page provided to a user. Method 400 generates a predictive model based on snapshots of individual users' credit file histories and attempts to find attributes of the credit file histories that have a high correlation to clicking or other consumption of a given advertisement. FIG. 4 illustrates a process flow directed to construction of a predictive model based on correlation between attributes of a credit file and attributes of an advertisement, in accordance with an example embodiment. Method 400 can be utilized to predict how likely a person will be to access an advertisement based on their credit file. An example of accessing an advertisement would be for an individual clicking on an advertisement on a web site.

Ad attributes that may be assessed in these correlation operations can include category or type information (such as an offer type), a product or service category or descriptor (brokerage account services, mortgage loan, home equity loan, car loans, insurance (home/life/auto), etc.),and context parameters (such as temporal parameters associated with when the ads were served, location parameters regarding the placement of the ad in the web page, etc.). User and credit file history attributes can include demographic information, as well as credit history information. Credit history information can include number of revolving accounts, averaging revolving balance, and payment history, as well as individual tradeline information. Tradeline entry information can include attributes, such as credit product type (mortgage, car loan, etc.), date of acquisition, original loan amount, current outstanding amount, and the like. Still further, raw attributes can be processed into other attributes based on a set of processing rules to be used in the correlation analysis. For example, a tradeline entry for an auto loan may be processed into an attribute value that indicates the number of months or days from the current time that the auto loan was originally entered into, or the number of months left on the loan. One skilled in the art that a wide variety of attributes can be analyzed, combined or otherwise used to create additional attributes that are used in the correlation analysis.

In one implementation, the correlation analysis can involve selecting a group of advertisements that share one or more attributes in common, identifying the individuals who were served with the ads (and those who accessed them), retrieving credit history data associated with the individuals, and then identifying those attributes of the credit history data that have a high correlation, or high predictive capability directed to, to accessing ads of that group or type.

Method 400, in a particular implementation, starts with credit report retrieval system 50 accessing a conversion data store including data characterizing performance of an advertisement or group of advertisements relative to one or more Patent individuals (402). The conversion data store can be populated in part by analysis of the logs maintained by advertising management system 30. The conversion data store contains data relating to individuals that accessed, and perhaps not accessed, an advertisement. The conversion data store could be maintained in, for example, advertising management system 30 and/or credit data retrieval system 50. Credit data retrieval system 50 accesses a credit history data store to obtain the credit files of the individuals identified in the conversion data store (404). Next, the server (52, 54, 55 or 56) of credit data retrieval system 50 correlates one or more attributes of the credit files of the one or more individuals and the activity of the one or more individuals relative to one or more attributes of the advertisement(s) (406). In one implementation, self-organizing maps are utilized in the correlating operation 406. A self-organizing map is an algorithm used to visualize and interpret large high-dimensional data set. The server (52, 54, 55 or 56) then constructs a predictive model, based on the correlating operation, operative to predict the likelihood that an individual, having a given credit history, will access a given advertisement or type of advertisement (408). The predictive modeling can be repeated for additional ad types or groups, as well. In addition, generation of the predictive model can be repeated in time as additional conversion data becomes available.

In one implementation, the predictive models can be used to assist in ad selection. For example, responsive to a request for a web page associated with a user, the credit history of the user can be an input to the model, which scores the relative likelihood that a user will click on one or more advertisement types. Ad selection can involve selecting an ad from a group of ads associated with the highest scoring ad type. In this manner, the predictive model can be utilized to select, for a given individual, an advertisement from a plurality of advertisements based on a credit file of the individual.

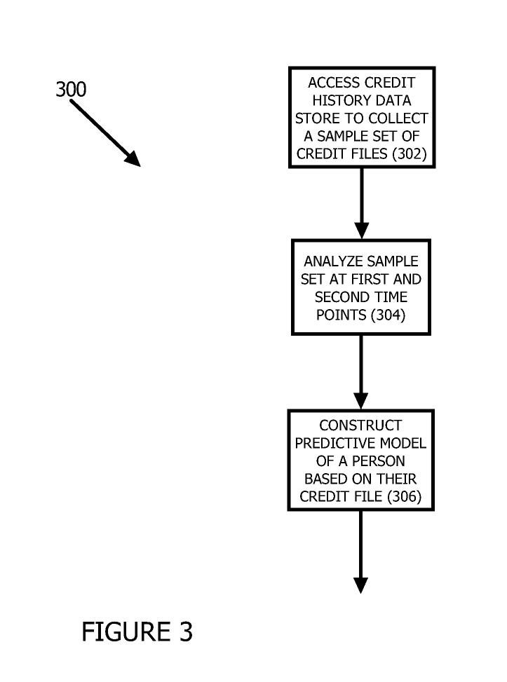

In other implementations, the correlation analysis can be used to determine the likelihood of a credit product acquisition or interest level in a credit product. FIG. 3 is a flowchart diagram illustrating a method 300 for constructing a predictive model based on credit files. Method 300 produces a predictive model which is operative to determine a likelihood that an individual will be making, or is interested in, a credit product acquisition. Method 300 can be practiced via the credit report retrieval system 50 of FIG. 1. Initially, credit report retrieval system 50 accesses a credit history data store, such as accessing credit reporting bureau 20 of FIG. 1, to collect a sample set of credit files each corresponding to an individual consumer credit history (302). Next, a server (52, 54, 55 or 56) of the credit report retrieval system 50 analyzes the sample set of credit files at first and second time points relative to a given credit product acquisition behavior to identify one or more attributes of a credit file that have a high predictive correlation to the credit product acquisition behavior (304). In one implementation, a likelihood to obtain a non-credit product is determined. Next, the server (52, 54, 55 or 56) then constructs a predictive model operative to determine the likelihood of the credit product acquisition behavior of a given individual based on a credit file of the given individual relative to the one or more attributes (306). Operation 304 can further include having the server (52, 54, 55 or 56) use the credit file samples to train a neural network to determine the likelihood of the credit product acquisition behavior of a given individual based on a credit file of the given individual.

The resulting predictive model can be used during a session involving an individual user and credit report retrieval system 50. For example, when a user logs in, credit report retrieval system 50 may access a credit file corresponding to the user, and run it against the predictive model to determine the most likely credit acquisition behavior of the user (e.g., such as a home equity line, or car loan). The credit report retrieval system 50 may then use this information in selecting one or more advertisements (such as banner advertisements in embedded in HTML pages) to display to the user, or for selection of an advertising type or category from which to select an ad.

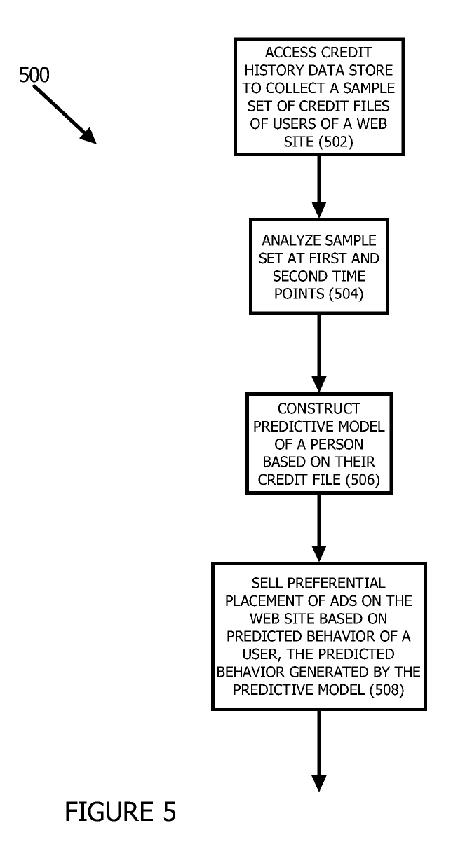

In other implementations, a temporal correlation-based analysis of credit histories can be used to predict the likelihood that a given user may acquire, or may be interested in, a particular credit or financial product, such as a home or auto loan. FIG. 5 is a flowchart diagram illustrating a method 500 for constructing a predictive model which can be utilized to sell preferential placement of advertisements on a web site, in accordance with an example embodiment. Method 500 generates a predictive model based on snapshots of an individuals' credit histories at different points in time and uses the predictive model to sell preferential placement of advertisements on a web site based on a predicted behavior of an individual relative to given credit product acquisition behavior.

The method 500 begins with credit report retrieval system 50 accessing a credit history data store to collect a sample set of credit files, each credit file corresponding to an individual consumer credit history of an individual user of a web site. Again, the credit data history store can perhaps be the credit reporting bureau 20 accessed by credit report retrieval system 50 of FIG. 1. Next, the server (52, 54, 55 or 56) of credit report retrieval system 50 analyzes the sample set of credit files at first and second time points relative to a given credit product acquisition behavior (such as a home loan, auto loan, student loan, etc.) to identify one or more attributes of a credit file that have a high predictive correlation to the credit product acquisition behavior. In turn, the server (52, 54, 55 or 56) constructs a predictive model operative to determine the likelihood of a given credit product acquisition behavior of a given individual based on a credit history of a given individual relative to the one or more attributes. The predictive model can be used to sell preferential placement of ads on the web site for users based on the predicted behavior of individual web site users relative to a given credit product acquisition behavior. For example, an advertiser of home loans, for example, may bid for placement of ads to users having a score (as determined by the predictive model) above a threshold value indicative of potential interest in home loans.

For all three of the above-described methods (300, 500, 500), examples of credit file attributes include, but are not limited to, a ratio of a number of revolving credit accounts vs. a number of installment credit accounts, a number of derogatory trade lines and years of credit history. Additionally, the predictive models for all three methods (300, 400, 500) can also be potentially constructed with inputs of meta-data related to the individual consumer. Examples of such meta-data include products purchased, a number of logins per month to a particular website, a referring website and keywords utilized in a search engine that results in a referral.

In one implementation, training epochs for predictive models, such as the predictive models of methods 300, 400 and 500, are the same as training intervals.

In one implementation, a desired outcome can be identified and the predictive models of methods 300, 400 and 500, and perhaps other models, can be utilized to identify individuals likely to arrive at the identified desired outcome. Additionally, a group of predictive models, such as the predictive models of methods 300, 400 and 500 and other models, can be utilized as a classifier model based on a multilayer perceptron, a radial basis function or a treenet network to produce a result from a discrete list of choices such as a type of next credit account - installment or revolving. Furthermore, a group of predictive models, such as the predictive models of methods 300, 400 and 500 and others, can also be utilized as tapped-delay multilayer perceptron or treenet model to predict a future event such as a number of days until a person will open a new line of credit or perhaps how large a person's next new line of credit will be.

In another implementation, the predictive models of methods 300, 400 and 500, and perhaps other models, can be adjusted after a training iteration based on result error. To achieve this, the result error can be evaluated and weights of each input are adjusted, for example, via back propagation of a multi-layer perceptron or radial basis function network.

In yet another implementation, predictive models, such as the predictive models of methods 300, 400, 500 and other models, are grouped and used as a “panel of experts” in that they will each be assigned contribution weights based on their predictive error of a desired outcome. The desired outcome can potentially map to a marketing offer. The process can be optimized via a genetic algorithm that can mutate and evaluate the contribution weights to achieve both a generalized and optimized learning engine which can potentially predict consumer behavior based on credit information and additional Internet metrics. The learning engine can then be deployed between a consumer and a consumer credit site. The learning engine can utilize calculated attributes from a credit file and other indicative inputs to produce a desired output prediction which can be used to display marketing offers deemed relevant to the consumer. Relevance can be considered to be a likelihood that the consumer will take advantage of a presented marketing offer. Furthermore, the learning engine and related underlying models can be updated on regular basis to adapt to changing market trends and consumer behavior.

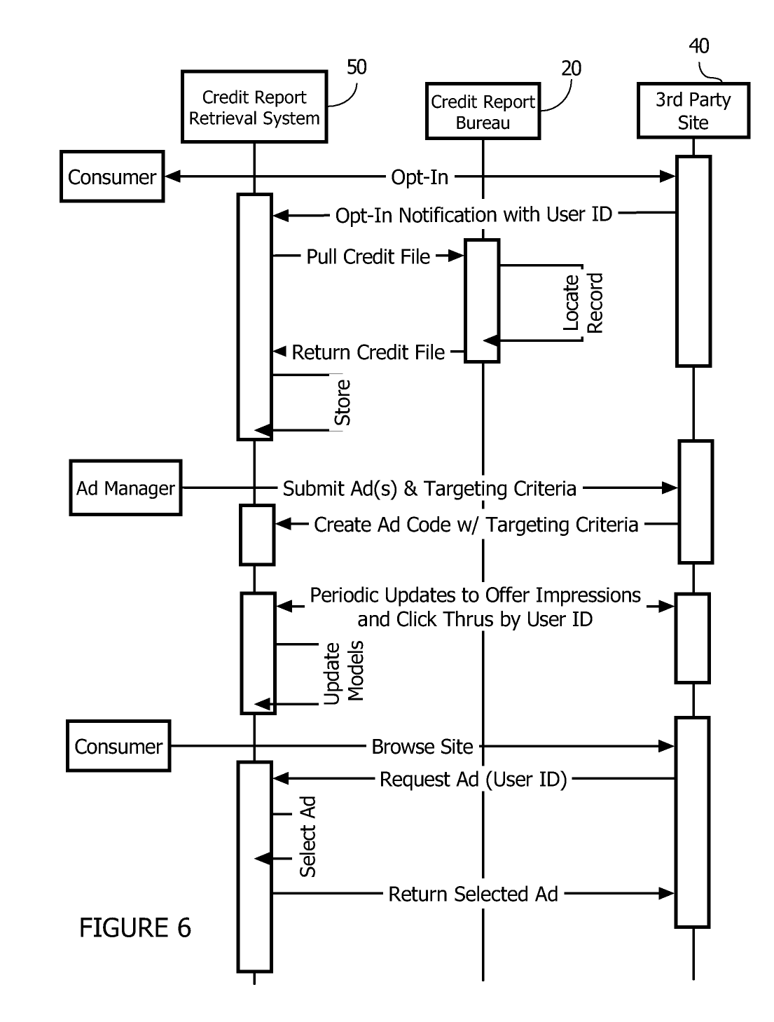

Still further, the predictive models described above can be utilized in other system architectures. For example, credit data retrieval system 50 can offer ad selection services to one or more third party systems, such as third party web site 40. In the system described below, credit data retrieval system 50 maintains the credit histories to enhance security, and provides access to predictive models and ad selection via application programming interfaces exposed to third party web site 40. As FIG. 6 illustrates, a consumer or user of a third party web site 40 may opt-in during a registration process or an account profile creation or updating process. Third party web site 40, if the user opts-in, may then transmit a request for the user's credit history, passing user identifying information (including a user account identifier), to credit data retrieval system 50. Responsive to the request, credit data retrieval system 50 may pull the user's credit data from one or more credit reporting bureaus 20, if it does not already have a recent copy, and maintain a copy of the credit data in association with the user account identifier supplied by third party web site 40.

In a separate process, an ad or offer manager may upload an ad and target user profile data to third party web site 40 or advertising management system 30. Third party web site 40 may create an ad identifier and provide the target user profile data and the ad identifier to credit data retrieval system 50. The ads submitted by third party web site 40 can then be associated in a pool of ads to be selected in response to requests for ads.

As FIG. 6 illustrates, when a consumer accesses a web page from third party web site 40, third party web site 40 transmits a request for an ad identifier to credit data retrieval system 50. In response to the request, credit data retrieval system 50 applies the credit data associated with the identifier user to one or more predictive models in order to select an ad. Credit data retrieval system 50 then returns the selected ad identifier in response to the request. In one implementation, the request for an ad may further include meta information, such as an ad category from which to select an ad, an ad position in a page, and the like.

In one implementation, third party web site 40 may embed in the ad served to the user, a hypertext link, image map or other control that resolves to a URL directed to ad management system 30. The URL may include the consumer's user identifier, as well as context information (such as a third party site identifier, etc.). When the user clicks on the ad or otherwise activates a control, a request (including the parameters discussed above) are passed to ad management system 30, which can log the click in connection with the parameters passed to it. As discussed above, this allows credit data retrieval system 50 and/or third party web site 30 to track clickstream activity and update its predictive models. In addition, other layers of redirection messages can be used to allow credit data retrieval system 50 and/or third party web site 30 to track clickstream activity of individual users. Other implementations are also possible. For example, credit data retrieval system 50 may expose the credit data attributes of users to partner third party web site 40, which can create and run its own predictive models for ad selection.

Although the functionality described above can be hosted in a wide variety of system architectures, FIG. 2 illustrates, for didactic purposes, a hardware system 800, which can be used to host one or more aspects of the functionality described above. Hardware system 800 can be utilized in the various systems shown in FIG. 1 such as the client computer 60 or servers. In one embodiment, hardware system 800 includes processor 802 and cache memory 804 coupled to each other as shown. Additionally, hardware system 800 includes high performance input/output (I/O) bus 806 and standard I/O bus 808. Host bridge 810 couples processor 802 to high performance I/O bus 806, whereas I/O bus bridge 812 couples the two buses 806 and 808 to each other. Coupled to bus 806 are network/communication interface 824, system memory 814, and video memory 816. In turn, display device 818 is coupled to video memory 816. Coupled to bus 808 are mass storage 820, keyboard and pointing device 822, and I/O ports 826. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 800 perform the functions described below. Mass storage 820 is used to provide permanent storage for the data and programming instructions to perform the above described functions implemented in the system controller, whereas system memory 814 (e.g., DRAM) is used to provide temporary storage for the data and programming instructions when executed by processor 802. I/O ports 826 are one or more serial and/or parallel communication ports used to provide communication between additional peripheral devices, which may be coupled to hardware system 800.

Hardware system 800 may include a variety of system architectures and various components of hardware system 800 may be rearranged. For example, cache 804 may be on-chip with processor 802. Alternatively, cache 804 and processor 802 may be packed together as a “processor module”, with processor 802 being referred to as the “processor core”. Furthermore, certain implementations of the present invention may not require nor include all of the above components. For example, the peripheral devices shown coupled to standard I/O bus 808 may be coupled to high performance I/O bus 806. In addition, in some implementations only a single bus may exist with the components of hardware system 800 being coupled to the single bus. Furthermore, additional components may be included in system 800, such as additional processors, storage devices, or memories.

In one embodiment, the operations of the claimed embodiments are implemented as a series of software routines run by hardware system 800. These software routines comprise a plurality or series of instructions to be executed by a processor in a hardware system, such as processor 802. Initially, the series of instructions are stored on a storage device or other computer readable medium, such as mass storage 820. However, the series of instructions can be stored on any suitable storage medium, such as a diskette, CD-ROM, ROM, etc. Furthermore, the series of instructions need not be stored locally, and could be received from a remote storage device, such as a server on a network, via network/communication interface 824. The instructions are copied from the storage device, such as mass storage 820, into memory 814 and then accessed and executed by processor 802. In alternate embodiments, the claimed embodiments are implemented in discrete hardware or firmware.

While FIG. 2 illustrates, for didactic purposes, a typical hardware architecture, the claimed embodiments, however, can be implemented on a wide variety of computer system architectures, such as network-attached servers, laptop computers, and the like. An operating system manages and controls the operation of system 800, including the input and output of data to and from software applications (not shown). The operating system provides an interface, such as a graphical user interface (GUI), between the user and the software applications being executed on the system. According to one embodiment of the present invention, the operating system is the Windows® 95/98/NT/XP operating system, available from Microsoft Corporation of Redmond, Wash. However, the claimed embodiments may be used with other operating systems, such as the Apple Macintosh Operating System, available from Apple Computer Inc. of Cupertino, Calif., UNIX operating systems, LINUX operating systems, and the like.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method comprising:
accessing a conversion data store including data characterizing performance of an advertisement relative to one or more individuals;
accessing a credit history data store to obtain the credit files of the one or more individuals;
correlating one or more attributes of the credit files of the one or more individuals to the activity of the one or more individuals relative to one or more attributes of the advertisement; and
constructing a predictive model, based on the correlating step, operative to predict the likelihood that a user will access a given advertisement type.

2. The method as recited in claim 1 wherein the predictive model is operative to predict likelihood of conversion based on one or more attributes of a given advertisement.

3. The method as recited in claim 1 further comprising using the predictive model to select, for a given individual, an advertisement from a plurality of advertisements based on a credit file of the individual.

4. The method as recited in claim 1 further comprising providing access to the predictive model via a set of application programming interfaces.

5. An apparatus comprising
one or more processors;
a memory;
a network interface; and
an ad selection application, physically stored in the memory, comprising instructions operable to cause the one or more processors to:
receive a request for an ad, wherein the request identifies a user;
access a data store of credit information for credit history information of the identified user;
apply the credit history information of the user against a predictive model that is operative to output a likelihood that the user will access ads corresponding respective advertisement types;
selecting an ad corresponding to an advertisement type based on the access likelihood output by the predictive model.

6. The apparatus of claim 5 wherein the predictive model is operative to predict likelihood of conversion based on one or more attributes of a given advertisement.

7. The apparatus of claim 5 wherein the ad selection application further comprises instructions operative to cause the one or more processors to use the predictive model to select, for a given individual, an advertisement from a plurality of advertisements based on a credit file of the individual.

8. The apparatus of claim 5 wherein the ad selection application further comprises instructions operative to cause the one or more processors to provide access to the predictive model via a set of application programming interfaces.

9. A method comprising:
accessing a credit history data store to collect a sample set of credit files, each credit file corresponding to an individual consumer credit history;
analyzing the sample set of credit files at first and second time points relative to a given credit product acquisition behavior to identify one or more attributes of a credit file that have a high predictive correlation to the given credit product acquisition behavior; and
constructing a predictive model operative to determine the likelihood of the credit product acquisition behavior of a given individual based on a credit file of the given individual relative to the one or more attributes.

10. The method as recited in claim 9 wherein the analyzing step further comprises training a neural network to determine the likelihood of the credit product acquisition behavior of a given individual based on a credit file of the given individual.

11. The method as recited in claim 9 wherein the given credit product acquisition behavior is a given non-credit product acquisition behavior.

12. A method comprising:
accessing a credit history data store to collect a sample set of credit files, each credit file corresponding to an individual consumer credit history of an individual user of a web site;
analyzing the sample set of credit files at first and second time points relative to a given credit product acquisition behavior to identify one or more attributes of a credit file that have a high predictive correlation to the credit product acquisition behavior;
constructing a predictive model operative to determine the likelihood of the credit product acquisition behavior of a given individual based on a credit file of the given individual relative to the one or more attributes; and
selling preferential placement of ads on the web site based on the predicted behavior of individual web site users relative to a given credit product acquisition behavior.

13. The method as recited in claim 12 wherein the given credit product acquisition behavior is a given non-credit product acquisition behavior.

14. The method as recited in claim 12 further comprising providing access to the predictive model via a set of application programming interfaces.
